(19) United States
(12) Patent Application Publication
(10) Pub. No.: US 2023/0289911 A1
(43) Pub. Date: Sep. 14, 2023

(54) ECOSYSTEM MANAGEMENT ENGINE IN A CARBON EMISSIONS MANAGEMENT SYSTEM

(71) Applicant: The Boston Consulting Group, Inc., Boston, MA (US)

(72) Inventors: Niels Martin Freier, Paris (FR); Charlotte Degot, Paris (FR); Olivier Roger Ali Kahn, Paris (FR); Henri François Louis VIGUIER, Paris (FR); Guillaume Henri Francois SAJUST DE BERGUES DE ESCALUP, Paris (FR)

(21) Appl. No.: 17/722,234

(22) Filed: Apr. 15, 2022

Related U.S. Application Data
(60) Provisional application No. 63/319,715, filed on Mar. 14, 2022.

(51) Int. Cl. G06Q 50/26; G06Q 10/10

(52) U.S. Cl. CPC G06Q 50/26; G06Q 10/101

(57) ABSTRACT

Methods, systems, and computer storage media for providing ecosystem carbon emissions data using an ecosystem management engine in a carbon emissions management system. The ecosystem management engine operates as a collaborative integration platform for managing carbon emissions associated with a client and suppliers of the client based on a plurality of ecosystem management operations (e.g., data exchange and aggregation, self-service carbon emissions calculations, data validation, and carbon reduction evaluation). In operation, using an ecosystem management engine, a client communicates a request for carbon emission data from a supplier of the client. The carbon emissions data comprises product-level data of the supplier. Based on communicating the request, the client receives the carbon emissions data. One or more ecosystem management operations are executed on the carbon emissions data. Based on executing the one or more ecosystem management operations, ecosystem carbon emissions data comprising client-supplier-specific carbon emissions data is generated and then communicated.

### CROSS REFERENCE SECTION

The present application claims the benefit of U.S. Provisional Application No. 63/319,715, filed Mar. 14, 2022 and entitled “ECOSYSTEM MANAGEMENT ENGINE IN A CARBON EMISSIONS MANAGEMENT SYSTEM”, the entirety of which is incorporated by reference herein.

### BACKGROUND

Many corporations rely on tracking systems to manage different aspects of their business platforms, from manufacturing processes to human resources. Carbon emissions management systems can be used to support their initiatives for limiting the environmental impact of their manufacturing processes. Companies can be required to track environmental metrics such as carbon emissions. For example, a corporation may track carbon emissions in order to manage sustainability data and report on their carbon footprint. A carbon emissions management system can operate based on measuring a carbon footprint for an individual, organization, or nation, where measuring the carbon footprint can be based on different types of carbon accounting techniques (e.g., greenhouse emissions assessment, a life cycle assessment).

Conventional carbon emissions management systems are not configured with a computing infrastructure and logic to provide greater and more sophisticated insights and trends in carbon emissions-related practices and to provide recommendations on how to meet carbon emissions goals or initiatives. For example, a conventional carbon emissions management system can provide a high level framework for calculating a total amount of carbon emissions, but lack granularity in carbon emissions data - especially client-supplier-specific carbon emissions information - that could help drive additional actions for meeting carbon cutting goals. As such, a more comprehensive carbon emissions management system, an alternative basis for performing carbon emissions management operations, can improve computing operations and interfaces for carbon emissions management.

### SUMMARY

Various aspects of the technology described herein are generally directed to systems, methods, and computer storage media, for among other things, providing ecosystem carbon emissions data using an ecosystem management engine in a carbon emission management system. The ecosystem carbon emissions data can include client-supplier-specific carbon emissions data, where the client-supplier-specific carbon emissions data is based on product-level data of the supplier. The ecosystem management engine operates as a collaborative integration platform for managing carbon emissions associated with a client and suppliers of the client - based on a plurality of ecosystem management operations (e.g., data exchange and aggregation, self-service carbon emissions calculations, data validation, and carbon reduction evaluation). In this way, the ecosystem management engine supports exchanging ecosystem carbon emissions data between a client and suppliers in a supply chain of the client; a self-service product emissions calculations service and interface for suppliers; and dialogue and coordination between the client and the suppliers around carbon emissions reduction (e.g., abatement levers).

In operation, using an ecosystem management engine, a client communicates a request for carbon emission data from a supplier of the client. Based on communicating the request, the client receives the carbon emissions data. The carbon emissions data comprises product-level data of the supplier. One or more ecosystem management operations are performed on the carbon emissions data. Based on performing the one or more ecosystem management operations, generating, using a carbon data analytics engine, ecosystem carbon emissions data comprising client-supplier-specific carbon emissions data associated with the product-level data of the supplier. The ecosystem carbon emission data is communicated and caused to be displayed via an ecosystem management interface with ecosystem management interface elements.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A — 1C are block diagrams of an exemplary carbon emissions management system with an ecosystem management engine, in which embodiments described herein may be employed;

FIGS. 2A and 2B are block diagrams of an exemplary carbon emissions management system with an ecosystem management engine, in which embodiments described herein may be employed;

FIG. 2C is an exemplary schematic associated with a carbon emissions management system with an ecosystem management engine, in which embodiments described herein may be employed;

FIGS. 2D - 2E are exemplary interfaces associated with a carbon emissions management system with an ecosystem management engine, in which embodiments described herein may be employed;

FIG. 3 is a flow diagram showing an exemplary method for implementing a carbon emissions management system with an ecosystem management engine, in accordance with embodiments described herein;

FIG. 4 is a flow diagram showing an exemplary method for implementing a carbon emissions management system with an ecosystem management engine, in accordance with embodiments described herein;

FIG. 5 is a flow diagram showing an exemplary method for implementing a carbon emissions management system with an ecosystem management engine, in accordance with embodiments described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION

### Overview

By way of background, carbon emissions management systems can be used to support their initiatives for limiting their environmental impact such as carbon emissions. For example, a corporation may track carbon emissions in order to manage sustainability data and report on their carbon footprint. A carbon emissions management system can operate based on measuring a carbon footprint for an individual, organization, or nation, where measuring the carbon footprint can be based on different types of carbon accounting techniques (e.g., greenhouse emissions assessment, a life cycle assessment). The carbon emissions management system can support developing a strategy to reduce the carbon footprint, for example, via carbon offsetting, carbon capture, better process management, energy efficient, and technological developments. The carbon emissions management system described herein corresponds to the carbon emissions management system in U.S. Appl. No. 17/690,787 entitled “CARBON EMISSIONS MANAGEMENT SYSTEM,” which is incorporated herein in its entirety.

Conventional carbon emissions management systems are not configured with a computing infrastructure and logic to provide sophisticated insights and trends in carbon emissions-related practices and provide recommendations on how to meet strategic goals with regard to carbon emissions initiatives. Many corporations commit to limit their environmental impact, in particular their carbon emissions, however, practically implementing initiatives can be challenging for different types of carbon emissions (e.g., scope-three carbon emissions that result from activities from assets not directly owned or controlled by a company). For example, a greenhouse gas (GHG) protocol corporate standard can define different types of carbon emissions, which are used by companies when reporting carbon emissions data and implementing carbon emissions reduction initiatives.

Companies struggle to reduce scope-three carbon emissions because traditional carbon emissions management systems do not adequately support managing scope-three carbon emissions. In particular, sharing scope-three carbon emissions data is difficult for a variety of reasons. For example, companies may find it difficult to manage data collection, evaluation, and processing efforts for a large number of suppliers. The data received may be of uncertain quality, leading a business to lack confidence in the data reported. The data may not be reported at the level of granularity needed to evaluate the efficacy of carbon control measures. Data may also not be reported in a timely manner to support business decision making. The problem is significant as a high percentage of carbon emissions are scope-three carbon emissions. Despite the challenge, many companies have committed to reduce carbon emissions by specific dates. The problem is further complex because to tackle scope-three carbon emissions companies need to go beyond their own boundaries and engage in ecosystem-wide reduction strategies.

By way of illustration, a company may find it challenging to provide carbon emissions reporting information because of lack of data associated with an upstream activity and a product of the upstream activity, both associated with a supplier. GHG emissions can be associated with the product, where the GHG emissions comes from the upstream activity (i.e., supplier activity) of a supply chain (i.e., client-supplier supply chain or value chain model) are not adequately allocated to the company as a scope-three upstream-carbon-emissions. In particular, a company may have no way to systematically gather information upstream supplier to request the necessary upstream-supplier carbon emissions information to support generating carbon emissions reporting data. In addition, there exists no mechanism to check the accuracy of the upstream-supplier carbon information.

Moreover, a company may also face challenges working with suppliers when trying to manage their carbon emissions associated with the supplier. For example, suppliers may also prefer to not share potentially sensitive data. Collecting the data may also involve manual collection processes, with each customer requesting different data or formats, an extremely time-consuming process when performed by hand. A further concern of suppliers may be a limited ability to amend or update data and the security of the data sent. And, suppliers may not have the means or capability to measure and collect carbon emissions data. Setting up or implementing collection processes are costly and time consuming.

Obtaining or deriving this data from other existing carbon emission factor databases is possible and embodiments disclosed herein offer tools and implementations that acquire such data. In this way, while a conventional carbon emissions management system can provide a high level framework for calculating a total amount of carbon emissions, but lack granularity in carbon emissions data — especially client-supplier-specific carbon emissions information — that could help drive additional actions that could help meet carbon cutting goals. As such, a more comprehensive carbon emissions management system, an alternative basis for performing carbon emissions management operations, can improve computing operations and interfaces for carbon emissions management.

Embodiments of the present disclosure are directed to systems, methods, and computer storage media, for among other things, providing ecosystem carbon emissions data using an ecosystem management engine in a carbon emission management system. The ecosystem carbon emissions data can include client-supplier-specific carbon emissions data, where the client-supplier-specific carbon emissions data is based on product-level data of the supplier. The ecosystem management engine operates as a collaborative integration platform for managing carbon emissions associated with a client and suppliers of the client based on a plurality of ecosystem management operations (e.g., data exchange and aggregation, self-service carbon emissions calculations, data validation, and carbon reduction evaluation). In this way, the ecosystem management engine supports exchanging ecosystem carbon emissions data between a client and suppliers in a supply chain of the client; a self-service product emissions calculations service and interface for suppliers; and dialogue and coordination between the client and the suppliers around carbon emissions reduction (e.g., abatement levers).

By way of context, companies may want to be transparent about their impact on the environment, as such, the companies may want to define and gather carbon emissions reporting information (i.e., carbon emissions data) associated with their specific industry sectors and geographic locations. Providing carbon emissions reporting information in this way can be based on environmental regulations associated with the particular geographic locations (e.g., country) and regulations for particular industry sectors. Specific environment regulations for each country can be stricter that other countries. As such, carbon emissions reporting information can be defined and gathered (e.g., via carbon emissions management system in U.S. Appl. No. 17/690,787 entitled “CARBON EMISSIONS MANAGEMENT SYSTEM) in a manner that facilitates reporting the carbon-emissions data not merely as rough estimates, but with granularity and specificity at both a company-level and a product-level.

An ecosystem management engine of the carbon emissions system can be configured to perform ecosystem management operations. The ecosystem management operations are executable on carbon emissions data that is defined and gathered in a manner that facilitates reporting client-supplier-specific carbon emission data. As used herein, “client” may refer to a manufacturer, organization, or company that has a relationship with a supplier, where the supplier performs and upstream activity associated with a product that is associated with a supply chain or value chain model of the client. The ecosystem management operations are associated with data exchange and aggregation, self-service carbon emissions calculations, data validation, and carbon reduction evaluation, as discussed in more detail herein.

Advantageously, the ecosystem management engine provides secured exchange of data in an end-to-end manner (e.g.., using data exchange and aggregation operations), where clients and suppliers have control over how to exchange data. The client request (e.g., request format) and supplier response (e.g., carbon emissions data) can specifically be defined in a manner that facilitates requesting product-level data and retrieving product-level data. The product-level data can refer to data that corresponds to a supply chain or value chain model of an upstream activity of the supplier (i.e., in contrast to activities of the client or client value chain model). The suppliers are provided with a tool (e.g., self-service carbon emissions calculation operations) to support generating the data request from the client. The ecosystem management engine further provides enhanced data quality. Data quality assurance (e.g., via data validation operations) provides reliable data to enable concrete actions to reduce carbon emissions. The data quality assurance measures are compliant with industry standards and provide safe data exchange while ensuring data privacy. For example, the product-level data can be compared to benchmarks or other thresholds such that alerts are generated when the product-level data or carbon emissions data associated with the product-level data are inconsistent with benchmarks or do not meetdefined thresholds. In addition, calculation models use transparent methodologies that may be used in sustainability audits.

The ecosystem management engine operates as a collaborative platform (e.g., via data exchange operations and carbon reduction evaluation operations) that allows clients and other suppliers to share ecosystem carbon emission data. For example, ecosystem carbon emissions can include effective abatement levers that enable initiatives at the ecosystem level. The participating clients and suppliers can track and share abatement levers and implementation status (e.g., an identifier associated with the status). Benchmarks may be sanitized and used as a self-assessment tool. Benchmarking can general refer to comparing supplier performance metrics to industry bests or best practices from other suppliers. For example, carbon emissions dimensions or carbon emission reduction dimensions can be measured and compared between suppliers, such that, suppliers have access to the comparison data (i.e., ecosystem carbon emissions data). Suppliers can use the self-service product emission calculator to measure progress against initiatives (e.g., self-service carbon emissions calculation operations).

As such, the ecosystem management engine can operate to generate and present ecosystem carbon emissions data that can include client-supplier-specific carbon emissions data, where the client-supplier-specific carbon emissions data is based on product-level data of the supplier. The ecosystem management engine supports providing a platform for product level climate and environmental data sharing and supply chain collaboration. The carbon emissions management system 100 provides secured data, end-to-end, with control of which data is shared with which parties. The carbon emissions management system 100 also provides collaborative data and idea sharing and enhanced data quality, while providing transparent methodology and calculations which can be audited by third parties.

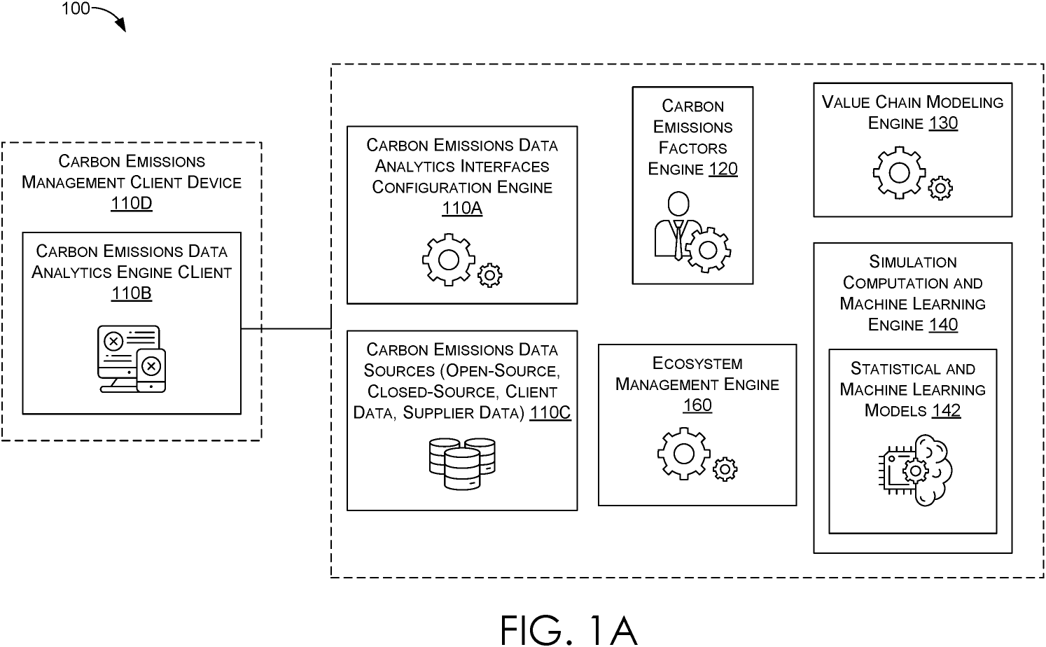

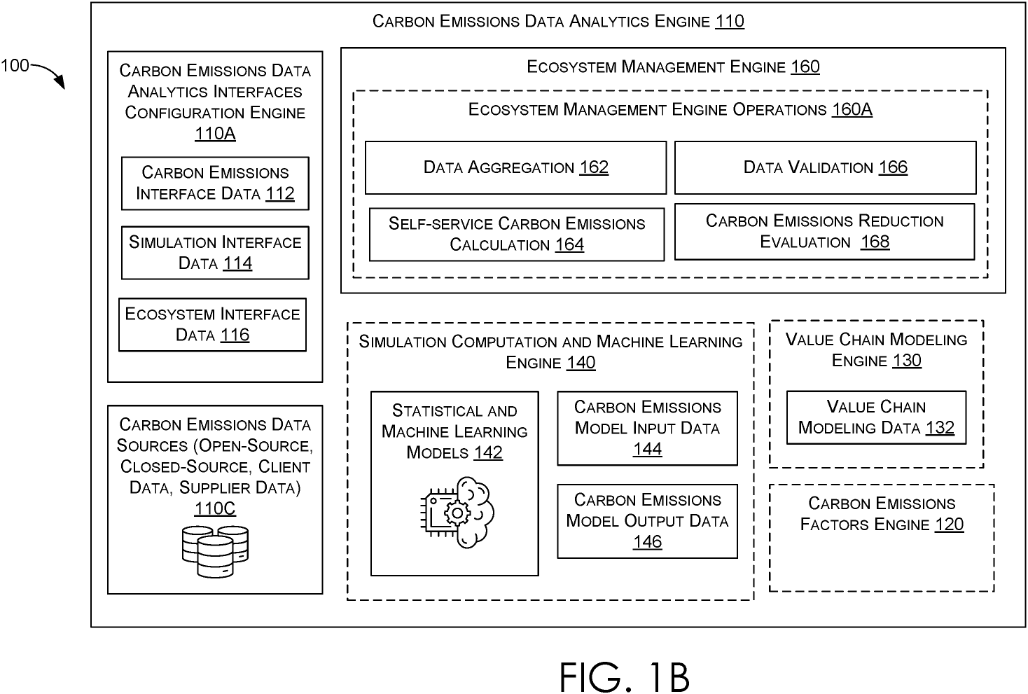

Aspects of the technical solution can be described by way of examples and with reference to FIGS. 1A — 1C. FIG. 1A illustrates a carbon emissions management system 100 including carbon emissions data analytics engine 110, carbon emissions data analytics interfaces configuration engine 110A, carbon emissions data analytics engine client 110D having carbon emissions data analytics engine client 110B, carbon emissions data sources 110C (e.g., open-source, close-source, client data, supplier data) and carbon emissions factors engine 120, value chain modeling engine 130, simulation computation and machine learning engine 140 having statistical and machine learning models 142; and ecosystem management engine 160.

With reference to FIG. 1B, FIG. 1B illustrates aspects of the carbon emissions data analytics engine 110. FIG. 1B includes carbon emissions data analytics interfaces configuration engine 110A having carbon emissions interface data 112, simulation interface data 114, and ecosystem interface data; carbon emissions data sources 110C (e.g., open-source, close-source, client data, supplier data); logic 122, enhanced carbon emissions factor data 124, value chain modeling engine 130 having value chain modeling data 132, simulation computation and machine learning engine 140 having statistical and machine learning models 142, carbon emissions model input data 144, and carbon emissions model output data 146, and ecosystem management engine 160 having ecosystem management engine operations 160A including data exchange and aggregation 162, self-service carbon emissions calculation 164, data validation 166, and carbon emissions reduction evaluation 168.

At a high level, the ecosystem management engine 160 supports using a plurality of ecosystem management engine operations (e.g., ecosystem management engine operations 160A) to process carbon emissions data from a supplier that is communicated to the client. Based on executing one or more ecosystem management operation ecosystem carbon emissions data comprising client-supplier-specific carbon emissions (associated with product-level data of the supplier) is generated. The ecosystem carbon emissions data is generated based in part on functionality associated with a carbon emissions management system, the functionality including consolidating and enriching carbon emissions factors (e.g., carbon emissions factors engine 120), modeling a value chain (e.g., value chain modeling engine 130); generating activity-carbon-emissions data via matching (e.g., matching logic 122 and activity-carbon-emissions data 124); visualizing baseline carbon emissions data (e.g., carbon emissions interface data 112 and carbon emissions data analytics interfaces configuration engine 110A); and simulating abatement levers from the baseline carbon emissions data (e.g., carbon emissions data analytics engine configuration engine). The carbon emissions system 100 implements statistical methods, advance forecasting and scenario modeling techniques (e.g., simulation computation and machine learning engine 140) to support the functionality described above.

In this way, ecosystem management operations can be complemented with simulation, computation, and machine learning engine 140 and statistical and machine learning models 142. The simulation, computation, and machine learning engine 140 uses the carbon emissions model input data as inputs to statistical and machine learning models 142 to baseline and provide insights on carbon emissions at a product-level granularity, where clients can receive emissions factors calculated at a product level. Carbon emission model input data include carbon emissions data that is provided from individual suppliers.

Operationally, a first carbon emissions data analytics engine client — for example, a client device of a client in a client-supplier relationship can be used to communicated a request to a second carbon emissions data analytics client (e.g., carbon emissions data analytics engine client 110B). The request comprises a structured carbon emissions request format (e.g., data request definition) for carbon emissions data of a supplier of the client. The structured request carbon emissions request format supports generating the request and supports the supplier in determining carbon emissions data that is requested. The request can request climate impact figures and other types of carbon emissions data. The supplier communicates the carbon emissions data (e.g., via the second carbon emissions data analytics client to the ecosystem management engine).

The ecosystem management engine supports performing a plurality of ecosystem management operations (e.g., ecosystem management operations including data exchange and aggregation, self-service carbon emissions calculation, data validation, and carbon reduction evaluation). Advantageously, the data exchange and aggregation operations allow for exchange of sustainability data between a client and their suppliers along supply chains that are agnostic to particular industries. The data aggregation operations support storing lists of suppliers, the products associated with suppliers and communicating data requests to the suppliers. And, data validation operations can support assessing quality of data received based on automated data quality checks and product-level benchmarks.

The data exchange operations further enable dialogues between different clients and suppliers. The self-service carbon emissions calculation operates to provide product carbon emissions calculation functionality to suppliers. A product emission footprint can be based on calculations using carbon emissions data from suppliers, where the carbon emissions data is processed via a carbon emissions data analytics engine (e.g., consolidating carbon emissions factor and performing calculation detains in a way to support transparency and audits by a third party).

The carbon reduction evaluation operations support coordinated emissions reduction initiatives. For example, abatement levers between a client and suppliers can be shared and also tracking functionality for clients to track a supplier’s abatement initiatives and compare the supplier to other suppliers using benchmarks. Based on performing the one or more ecosystem management operations, ecosystem is carbon emissions data comprising client-supplier-specific carbon emissions data associated with the product-level data of the supplier. The ecosystem carbon emission data is communicated and caused to be displayed via an ecosystem management interface with ecosystem management interface elements.

Ecosystem management functionality can be complemented with functionality associated with other functionality associated with the carbon emissions management system. The carbon emissions management system supports the following: merging and augmenting existing carbon emission factor databases and standard activities via statistical modelling to generate an enhanced carbon emissions factors database; automatically mapping activity data for an entity with the enhanced carbon emissions factors database; leveraging advanced analytics techniques to extract actionable abatement levers from the carbon emissions data — through forecasting, scenario simulation, and scenario optimization; and embedding the carbon emissions analytics model into an automated collaborative platform which offers an intuitive dashboard, scenarios versioning and simulations and optimization functionality. For example, the self-service product emission calculator can be utilize the simulation computation and machine learning engine to generate estimates of product carbon footprints through carbon emission artificial intelligence capabilities. In addition, companies can receive transparent calculation details that are compliant with international standards.

The carbon emissions management system can operate to quantify carbon emissions. Carbon emissions can be quantified as carbon emissions data and specifically for a company’s activities (e.g., a value chain model or client-supplier value chain model). A value chain model can model a client-supplier value chain or supplier activities that generate a product as product-level activities (i.e., in contrast with company-level activities) such that the value chain model supports quantifying carbon emissions at the product-level corresponding to product-level data. Quantifying carbon emissions can be based on a mixture of statistical methods, advance forecasting and scenario modeling techniques. In this way, the carbon emissions management system supports fast and accurate results data and enables simulation-based decisions and specifically what abatement levers provide a desired outcome for carbon emissions at scale. Statistical methods, from simple regression to full-fledged machine-learning models are used to make inferences of missing data in the enhanced carbon emissions factor database. For example, an inference can be made with reference to the energy intensity of a processing step — in the value chain model — in a country for which the data does not exist. In this way, missing data is inferred using statistical methods, e.g. multi-variate regressions.

Operationally, the carbon emissions management system consolidates and enriches emission factors. The emissions factors can be defined in an enhanced carbon emissions factors database. The carbon emission library can be generated by consolidating open-access data and also based on acquiring licenses database. In addition, the enhanced carbon emissions factors database can be extended to include computed emissions factors for complex products and processes. The carbon emissions management system processes a value chain model for a particular supplier and matches the value chain model the carbon emissions factor database. Based on matching the value chain model to the carbon emission factor database, a baseline carbon emissions model is generated. The baseline carbon emissions model can be provide as a visualization that can be controlled based on changing inputs to simulate abatement levers starting from the baseline.

The carbon emissions management system can include different types of data visualizations including the following: standardized visualizations (e.g., an interactive heat map) which can be explored by drilling into the activities tree to any required level of granularity; future projections of the emissions and carbon offsetting costs; comparison screens (waterfall-like) showing the impact of abatement simulations compared to the baseline. Simulating the effect of select abatement levers on the emission baseline can be based on a mix of simple formulae, stochastic simulations (MCMC) and math (e.g. installing solar panels on X stores in five countries, optimizing routing in transport networks, switching a source material for a sustainable alternative). Optimization techniques (e.g. MIPs) to simulate the effects of select abatement levers on the emissions baseline.

With reference to FIG. 1C, FIG. 1C illustrates a product ecosystem 100X. The product ecosystem 100X provides an overview of each of the sub-products and sources of the total carbon emissions resulting from producing a product 102. Product 102 can be comprised of multiple sub-products that are assembled to produce the end product. Each of the separate components of product 102 incurs a carbon emission cost when incorporated during the assembly and distribution of product 102. Product 102 can be associated with activities that correspond to product-level data. For example, product 102 may incorporate a number of sub-products or subassemblies, such as first tier subassemblies 104a — 104n. Each of the subassemblies 104a — 104n reflects the carbon assemblies of the subassemblies comprising the first tier subassemblies 104a — 104n. A carbon emission cost of each component becomes part of the total carbon emissions for product 102. In turn, each of the subassemblies 104a — 104n may incorporate second tier subassemblies 106a — 106n, which in turn may incorporate third tier subassemblies 108a — 108n. The carbon emissions are again added to the carbon emissions totals for product 102.

By way of example, the manufacturer of product 102 may have committed to carbon emissions goals, but may have limited ability to affect or direct suppliers to reduce carbon emissions. In some instances, suppliers may be understandably reluctant to share production details and data with other manufacturers, such as the manufacturer of product 102. This lack of transparency can hinder progress by clients. The carbon emissions management system 100 allows suppliers to input data directly to the carbon emissions management system 100. For example, the first tier subassemblies 104a — 104n manufacturers can submit carbon emissions data directly to the carbon emissions management system 100, bypassing the manufacturer of product 102. The carbon emissions data submitted by the suppliers is encrypted, anonymized, and secured in the infrastructure of carbon emissions management system 100, which also facilitates safe data exchange.

The carbon emissions management client device 110D communicates with carbon emission management data exchange 110E. The carbon emissions management data exchange 110E includes carbon emissions data analytics interfaces configuration engine 110A. The carbon emissions data analytics interfaces configuration engine 110A receives carbon emissions interface data and may also provide simulation interface data and ecosystem interface data, as part of the carbon emissions management system 100 calculations. Carbon emissions data sources 110C stores data from clients, such as the first, second, and third tier suppliers discussed above, as well as open source data and closed source data.

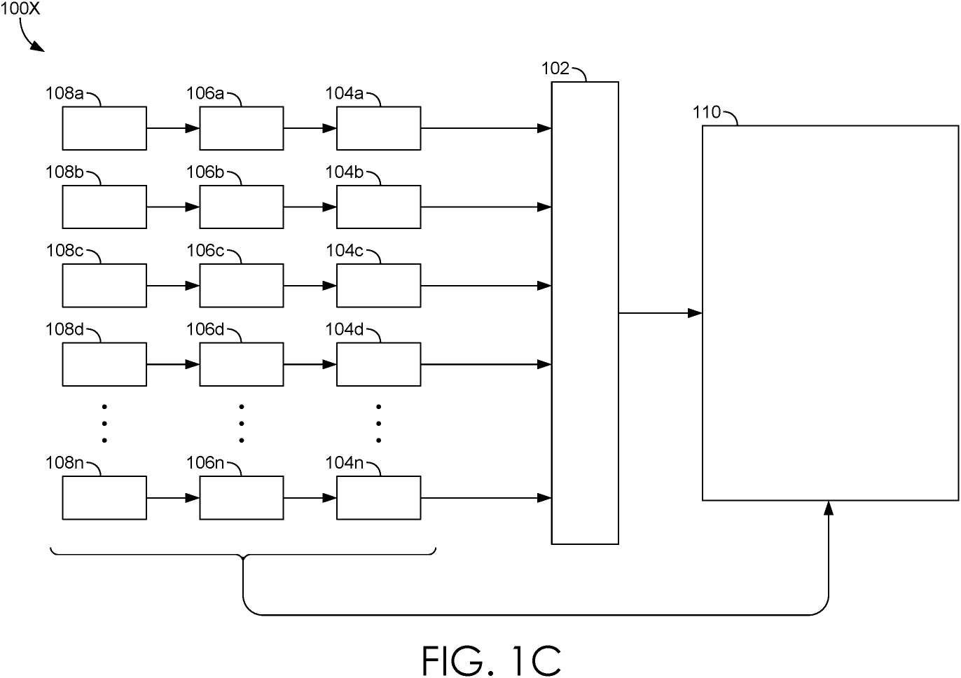

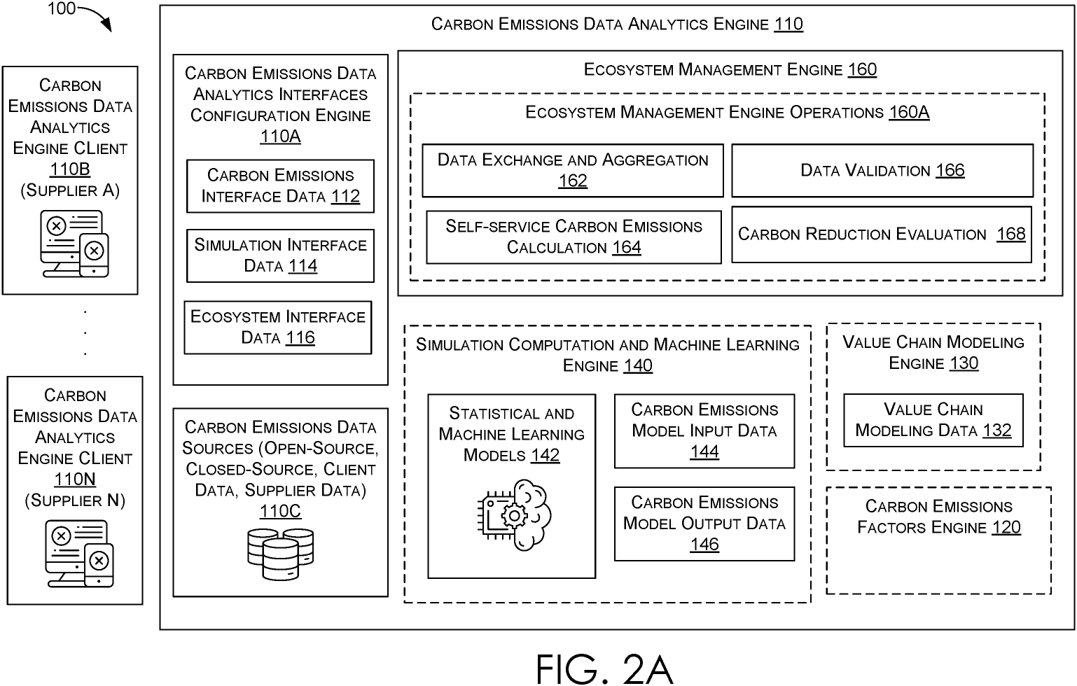

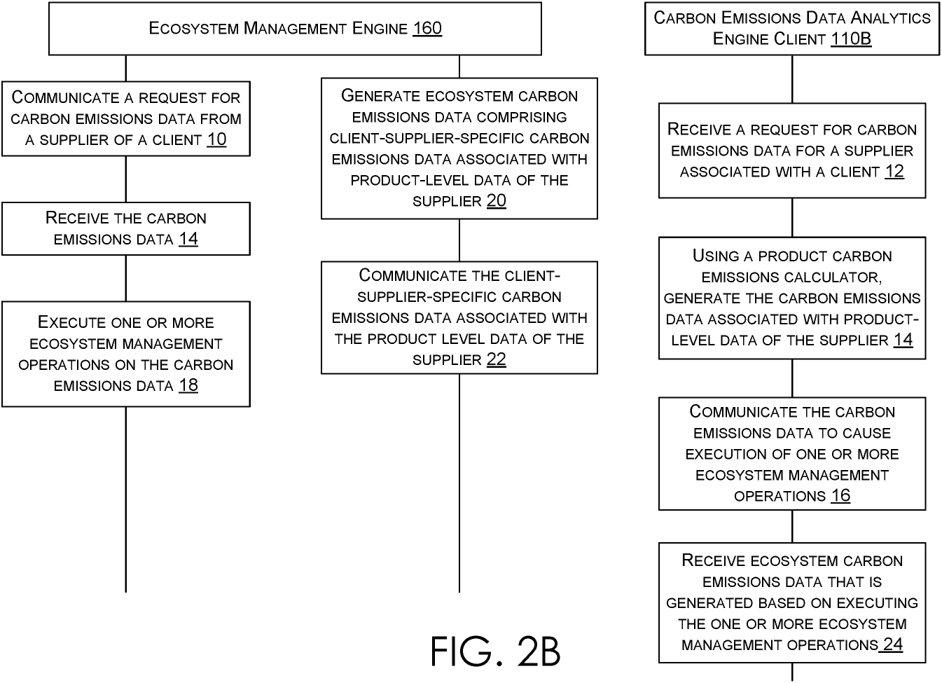

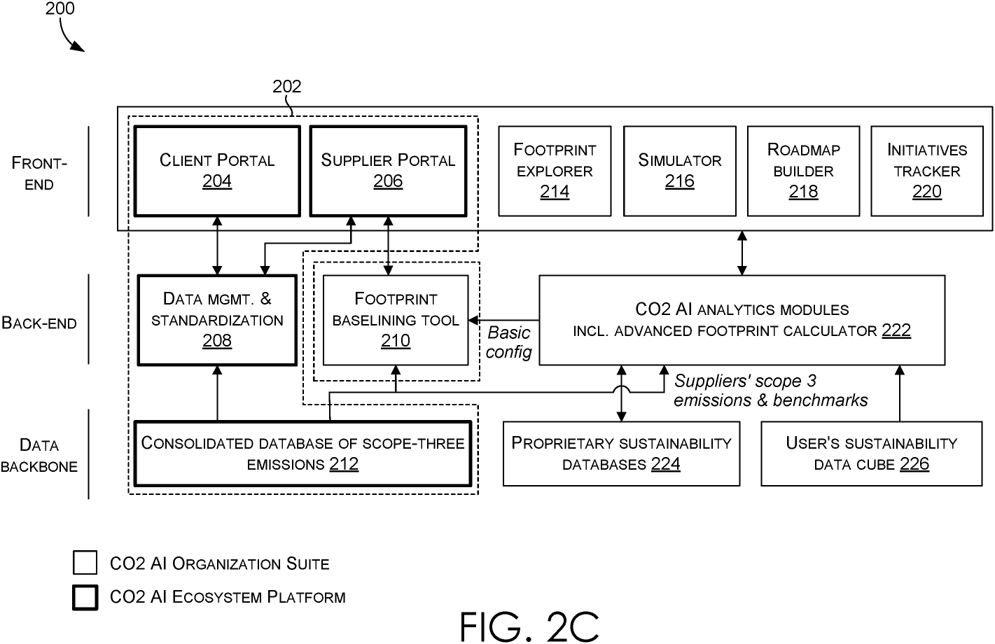

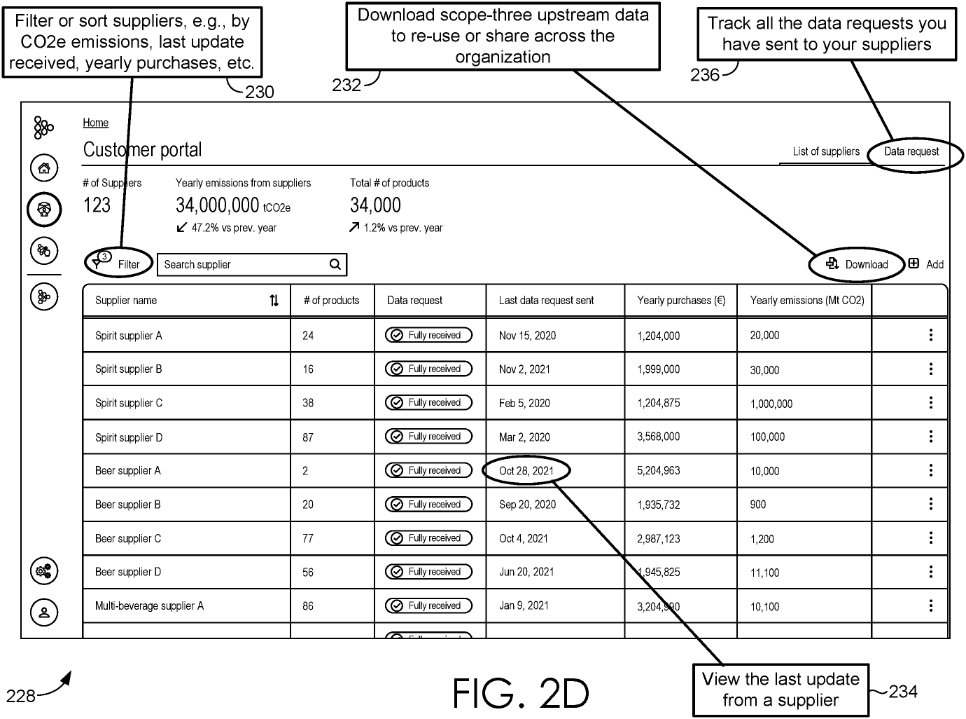

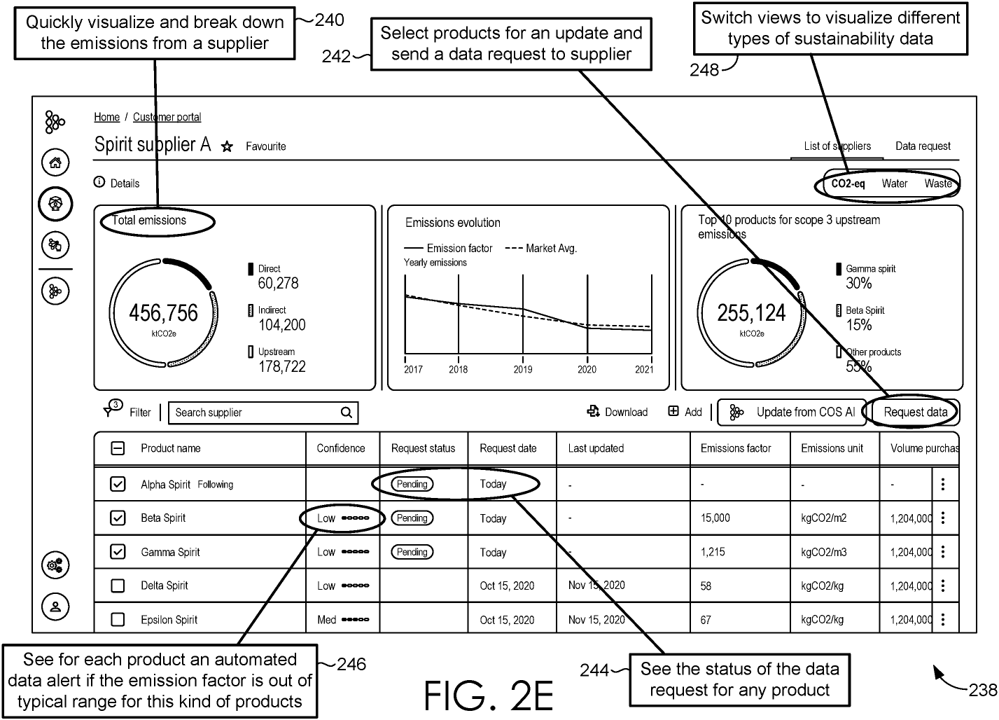

With reference to FIG. 2A, FIG. 2A illustrates a carbon emissions management system 100 including carbon emissions data analytics engine 110, carbon emissions data analytics interfaces configuration engine 110A, carbon emissions data analytics engine client 110D having carbon emissions data analytics engine client 110B through carbon emissions data analytics engine client 110N, carbon emissions data sources 110C (e.g., open-source, close-source, client data), carbon emissions factors engine 120, value chain modeling engine 130, and simulation computation and machine learning engine 140 having statistical and machine learning models 140.

The carbon emissions factors engine 120 includes matching logic 122, enhanced carbon emissions factor data 124, and activity-carbon-emissions data 126, the value chain modeling engine 130 includes value chain modeling data 132, simulation computation and machine learning engine 140 includes statistical and machine learning models 142, carbon emissions model input data 144, and carbon emissions model output data; and ecosystem management engine operations 160A including data exchange and aggregation 162, self-service carbon emissions calculation 164, data validation 166, and carbon emissions reduction evaluation 168.

The ecosystem management engine 160 supports generating ecosystem carbon emission data. Ecosystem carbon emissions data can include client-supplier-specific carbon emissions data. The client-supplier-specific carbon emission data includes product-level data of the supplier. The ecosystem carbon emissions data can also refer to carbon emissions results data that is generated based on operations performed on the carbon emissions data from a supplier for a supply chain or value chain between the supplier and the client. For example, the ecosystem carbon emissions data can be simulated carbon emission optimization results data based on a carbon emissions data analytics models of the carbon emissions management system.

Carbon emissions factors engine 120 can consolidate and enrich carbon emission factors, based on data collection and analytical inferences. These factors may be used to perform an emissions calculations and update of carbon emissions baselines. The value chain modeling engine 130 performs calculations on costs associated with various strategies and data points, allowing a user or company to see the potential cost or savings of various carbon emission reduction strategies.

The carbon emissions management system 100 assists with consolidating and enriching carbon emissions factors through carbon emissions factors engine 120, modeling a value chain, through value chain modeling engine 130, generating activity-carbon-emissions data via matching through value chain modeling data 132 and activity-carbon-emissions data 124, visualizing baseline carbon emissions data, using carbon emissions interface data 112 and carbon emissions data analytics interfaces configuration engine 110A; and simulating abatement levers from the baseline carbon emissions data, through the carbon emissions data analytics engine configuration engine. The carbon emissions management system 100 implements statistical methods, advance forecasting and scenario modeling techniques to support the described functionality.

In operation the carbon emissions factors engine 120 consolidates and enriches the carbon emissions factors that have been input into the carbon emissions factors database. The carbon emissions factors database can include the emissions factors for products and sub-products, such as shown in FIG. 1C. Data for each product and sub-product may be identified by manufacturer for each product in the production chain.

Client data may be input communicated using a secure interface and portal. The carbon emissions data analytics interfaces configuration engine 110A and the carbon emissions data sources 110C provide input to the carbon emissions factors engine 120. The carbon emissions factor engine 120 includes matching logic 122, enhanced carbon emissions factor data 124, and activity carbon emissions data 126.

Value chain modeling engine 130 operates in communication with the carbon emissions factor engine 120. The value chain modeling engine 130 includes value chain modeling data 132. The value chain modeling engine 130 is also operates in communication with simulation, computation, and machine learning engine 140. The simulation, computation, and machine learning engine 140 includes statistical and machine learning models 142, carbon emissions model input data 144, and carbon emissions model output data 146.

The carbon emissions management system 100 provides a collaborative data exchange platform that shares and collects product-level data through a secured infrastructure. Data input to the carbon emissions management system 10 as carbon emissions data sources 110C is checked and scored for confidence. The data input can then be used to provide an ecosystem emission reduction coach that allows suppliers at multiple levels to collaborate, share ideas on abatement measures, and track implementation status. Suppliers can use the carbon emissions management system 100 to assess their own performance against benchmarks, whether internal or external. The carbon emissions management system also incorporates a product emission calculator enabling suppliers to estimate their product’s carbon footprint by leveraging machine learning models with transparent calculations.

The data exchange feature begins with a data request definition. The company defines a data request by listing products and granularity requirements for each supplier. The data request definition is the initial input to the carbon emissions management system 100. In response to the data request definition, verified data from suppliers is automatically ingested into the carbon emissions management data exchange. This data may include data insights tools, including industry benchmarks, initiatives simulator, initiatives tracker, roadmap builder, and emissions reduction through artificial intelligence driven optimization. Once this data is ingested from all requested suppliers, the customer emission baseline is updated. The uploaded data may be audited by a third party.

Once the baselining update is complete, a unique data request is sent by the customer to each of the selected suppliers. These suppliers may be selected from suppliers 104A — 104N, 106Aa — 106N, and 108A — 108N in FIG. 1C. Each supplier calculates and uploads emissions data at the product level. The suppliers may also use the product emission calculator to accomplish the calculations. Suppliers upload their data directly to the carbon emissions management data exchange, preserving confidentiality and security. The uploaded data is automatically checked and audited against data quality rules and benchmarks. Any suspicious data points are flagged for further review by the customer. Data validation and certification ensure trust in the data shared through the carbon emissions management system.

The data request is underpinned by a number of guiding principles. Every data point collected should have a clear use case and be a reasonable request of a supplier. Suppliers do not need to rework the data submitted in response to a data request. The data request form also ensures that the data request is compliant with existing structures and protocols, such as the GHG protocol. The data request further ensures that the emission savings are attributable to a particular customer, product, supplier, or technology. The data request is also formatted to ensure that data is consistent across users. In addition, several types of sustainability data can be exchanged, carbon emissions data, water, and waste data can also be included in a data request. Company-level data can be used to cross-check a “bottom up” footprint calculated with product-level data with a “top down,” or spend-based company level figure.

Data harmonization can be implemented to generate product-level benchmarks, augment carbon emissions databases and to enable data alerts on the carbon emissions data management system. Harmonizing names of multitudes of products across value chains is complex and time consuming. The carbon data emissions management system uses high level product taxonomies to assist in providing the granularity to view emissions at a product level. This poses significant challenges, as more granular taxonomies may not exist for some products and industries. Data harmonization can be performed to generate carbon emission benchmarks, which can then be added to the carbon emissions AI database as upgrades. These upgrades allow the creation of a new emissions factor data of composite products. This provides for differentiating between two or more types of products, raw material, such as glass or beer, and the composite product, beer in a glass bottle.

The value chain modeling engine 130 operates to generate value chain models based on activity data. Activity data can be associated with individual activities of a value chain models. For example, the value chain model can be associated with a manufacturing process that includes transportation of raw resources or materials, processing of the resources, and delivery of finished products to a next manufacturer who may incorporate that manufactured item in a further product. Thus, the data collected can be used to generate a total carbon emissions value for a manufactured product incorporating multiple sub-products. Activity data, including client data can be processed to generate value chain models that are stored as processed as value chain modeling data 132 to support quantifying carbon emission data for the carbon emissions sources of the value chain model.

The carbon emissions factors engine 120 operates to generate activity-carbon-emissions data 126. The activity-carbon-emissions data 126 is generated using matching logic 122 (e.g., fuzzy matching or string matching) and enhanced carbon emissions factor data 126. Value chain modeling data (e.g., granular hierarchical tree of activities) is mapped to enhanced carbon emissions factor data using multiple techniques. As one example, fuzzy matching can be used to match the descriptions of an activity to a description of a carbon emissions factor. The granularity of the tree of activities in combination with statistical methods improves the accuracy of the carbon emissions management system. Statistical methods such as simple regression, multi-variate regression, or machine learning models, are used to infer missing data in the carbon emissions factor data. For example, an inference can be made with reference to the energy intensity of a processing step in the value chain model, in a country for which the data is missing or not available. Data augmentation can also be used to generate synthetic data, including synthetic carbon emissions data that can be used to generate activity-carbon-emission-data.

The carbon emissions data analytics interfaces configuration engine 110A operates to provide carbon emissions interface data 112 and simulation interface data and ecosystem carbon emissions data, discussed further below. The carbon emissions factor engine generates activity-carbon emissions data which is used to generate the carbon emissions interface data 112. The simulation computation and machine learning engine 140 can be used to generate the simulation interface data 114 associated with assessing the effect of different abatement levers, or mitigation efforts.

Abatement levers may refer to activities or actions that can be selected to reduce carbon emissions. Each abatement lever may be associated with a quantified measure of potential carbon emission reduction. As one example, installing solar panels on a number of stores in five countries can result in reduced carbon emissions. Other abatement levers could optimize transport routing or selecting a more sustainable source material in a process are other examples of abatement levers that can be selected. Selecting abatement levers allows assessment of the effect of the levers is thus based on client-specific simulations that are built upon simulation computation in conjunction with machine learning statistical methods, advance forecasting, and scenario modeling techniques. This allows the carbon emissions management system to provide simulations and to prioritize abatement levers.

The carbon emission data analytics interfaces configuration engine 110A uses output data, that is, the carbon emissions model output data, generated from the input data. The input data is the carbon emissions model input data. As a result, different types of data visualization can be provided, including: standardized visualizations such as an interactive heat map, future projections of the carbon emission and carbon offset costs, comparison screens showing the effect of abatement simulations as compared to the baseline. The simulations can be based on a mix of simple formulas, stochastic simulations (MCMC), and the like. Optimization techniques can be implemented to simulate the effects of selecting different abatement levers on the emissions baseline.

With reference to FIG. 2B, FIG. 2B illustrates carbon emissions management system with ecosystem management engine 160 and carbon emissions data analytics engine client 110B for providing ecosystem carbon emissions data. At block 10, communicate a request for carbon emissions data from a supplier of a client. At block 12, receive a request for the carbon emissions data for the supplier associated with the client. At block 14, using a product carbon emissions calculator, generate the carbon emissions data associated with product-level data of the supplier. At block 16, communicate the carbon emissions data to cause execution of one or more ecosystem management operations. At block 18, receive the carbon emissions data. At block 20, execute one or more ecosystem management operations on the carbon emissions data. At block 22, generate, using a carbon data analytics engine, ecosystem carbon emissions data comprising client-supplier-specific carbon emissions data associated with product-level data of the supplier. At block 24, communicate the client-supplier-specific carbon emissions data associated with the product-level data of the supplier. At block 26, receive ecosystem carbon emissions data that is generated based on executing the one or more ecosystem management operations.

The ecosystem carbon emissions data is caused to be displayed using ecosystem carbon interface elements via an ecosystem management interface. Displaying of the ecosystem carbon emissions data can include generating the interactive dashboard visualizations with graphical interface elements that correspond to carbon emissions output data associated with the ecosystem carbon emissions data and carbon emissions data analytics recommendations. For example, simulated carbon emissions optimization results can be presented as illustrated in FIG. 2D. The interactive dashboards of FIGS. 2D and 2E allow users to see and view supplier carbon emissions data and to track data requests sent to suppliers.

With reference to FIG. 2C, FIG. 2C is a block diagram of the carbon emissions management system 200 including an ecosystem management engine 202. The ecosystem management engine 202 can correspond to ecosystem management engine 160 of FIGS. 1A and 1B, where ecosystem management engine 202 further includes a client portal 204 and a supplier portal 206. The client portal 204 is where a customer, such as a manufacturer of a product, enters data and initiates data requests. The supplier portal 206 is where suppliers may respond to data requests by inputting information in response. Both the client portal 204 and the supplier portal 206 communicate with the data management and standardization module 208. The data management and standardization module 208 perform the data validation, verification, and security processes described above. If warranted by the input data, an audit response flag may be set by the data management and standardization module 208. The audit response flag directs a requesting customer to review the data in question.

The data management and standardization module 208 is also in communication with the consolidated database of scope-three emissions 212. The consolidated database of scope-three emissions 212 is in communication with the footprint baselining tool 210 and also the supplier portal 206, ensuring that relevant data is shared across the ecosystem 202. The footprint baselining tool 210 communicates outside the ecosystem 202 to the carbon emissions organization suite which comprises footprint explorer 214, simulator 216, roadmap builder 218, initiatives tracker 220, carbon analytics AI modules, including an advanced footprint calculator 222. The carbon analytics AI modules are also in communication with proprietary sustainability databases 224 and the user’s sustainability data cube 226.

With reference to FIG. 2D, FIG. 2D depicts a dashboard of suppliers 228. The dashboard of suppliers 228 can be produced once the data requests responses have been uploaded and verified. The dashboard of suppliers 228 allows a requesting company to filter 230 or sort suppliers, such as by carbon emissions, last update, yearly purchases, and similar data. In addition, the dashboard of suppliers 228 allows users to download 232 scope-three upstream data to reuse or share across the organization. This provides an upstream view of the suppliers’ carbon emissions data that the requesting company can use to evaluate scope-three emissions. The dashboard of suppliers 228 also allows users to view 234 the last update from a supplier. The dashboard provides a searchable list so the requesting companies can track all of the data requests sent to suppliers and can view the date data was previously submitted. The requesting company can also track 236 data requests sent to suppliers.

With reference to FIG. 2E, FIG. 2E shows an individual supplier dashboard 238. Companies can perform a deep dive on an individual supplier and may view all of the products purchased from that supplier. The individual supplier dashboard 238 allows a company view a supplier emissions break down 240. The total emissions may be shown as direct, indirect, and unknown emissions contributions. While viewing the dashboard a requesting company can visualize and break down all of the carbon emissions from that supplier. A user can select 242 products can be directly from the individual supplier dashboard 238 and can see the status 244 of a data request for any product. Automated data alerts 246 also appear on the dashboard whenever an emission factor is out of the typical range for the type of product being viewed. A user may switch 248 between different views may be selected, and vary with the types of sustainability data presented.

### Exemplary Methods

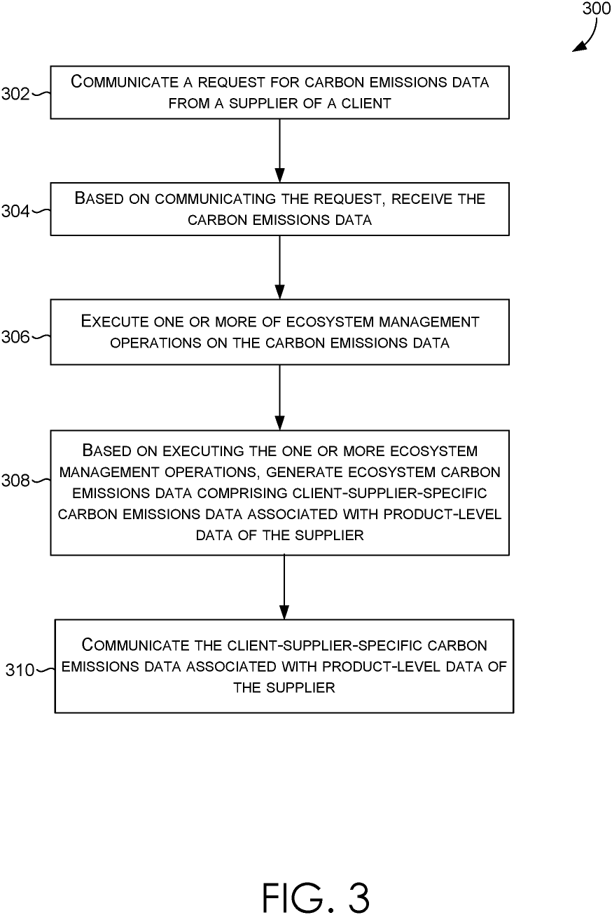

With reference to FIGS. 3, 4 and 5, flow diagrams are provided illustrating methods for providing ecosystem carbon emission data using an ecosystem management engine in a carbon emissions management system. The methods may be performed using the carbon emissions management system described herein. In embodiments, one or more computer-storage media having computer-executable or computer-useable instructions embodied thereon that, when executed, by one or more processors can cause the one or more processors to perform the methods (e.g., computer-implemented method) in the carbon emissions management system (e.g., a computerized system or computing system).

Turning to FIG. 3, a flow diagram is provided that illustrates a method 300 for providing ecosystem carbon emission data using an ecosystem management engine in a carbon emissions management system. At block 302, communicate a request for carbon emissions data from a supplier of a client. At block 304, based on communicating the request, receive the carbon emissions data. The carbon emissions data comprises product-level data of the supplier. Communicating the request and receiving the carbon emissions data is based on a data request definition associated with a product and product-level carbon emissions data associated with a value chain model of the client and the supplier. The carbon emissions data is generated based on self-service product emissions calculation operations that are associated with the carbon emissions data analytics model for calculating carbon emissions data for the supplier. The self-service product calculation operations support generating alerts based on benchmarking the carbon emissions data of the supplier.

At block 306, execute one or more ecosystem management operations on the carbon emissions data. Executing the one or more ecosystem management operations comprises performing data validation based on a plurality of data quality rules and benchmarks for carbon emissions data associated with suppliers. Executing the one or more ecosystem operations comprises communicating one or more abatement levers that are identified based on processing the carbon emissions data of the supplier using a carbon emissions data analytics machine learning model. Further, executing the one or more ecosystem management operation comprises tracking carbon emissions initiatives for the supplier, where the ecosystem carbon emissions data is generated for tracking carbon emissions initiatives and indicates an implementation status of one or more abatement levers associated with the supplier. At block 308, based on executing the one or more ecosystem management operations, generate, using a carbon emissions data analytics engine, ecosystem carbon emissions data comprising client-supplier-specific carbon emissions data associated with product-level data of the supplier.

At block 310, communicate the client-supplier-specific carbon emissions data. Communicating the ecosystem carbon emissions data comprises causing display of ecosystem interface data comprising dashboard visualizations having ecosystem carbon emissions data graphical interface elements corresponding to the ecosystem carbon emissions data. The ecosystem carbon emissions data includes a carbon emissions data analytics recommendation comprising simulated carbon emissions optimization results data based on predicted carbon emissions data generated using a simulation computation and machine learning engine, the predicted carbon emissions data is associated with a value chain model of the client and supplier.

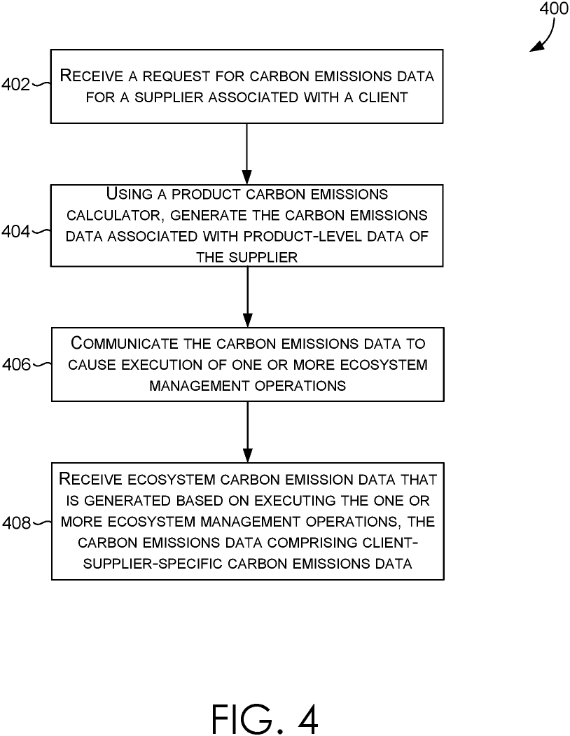

Turning to FIG. 4, a flow diagram is provided that illustrates a method 400 for providing ecosystem carbon emission data using an ecosystem management engine in a carbon emissions management system. At block 402, receive a request for a supplier associated with a client. Using a product emissions calculator, generate the carbon emissions data associated with product-level data of the supplier. At block 408, communicate the carbon emissions data to cause execution of one or more ecosystem management operations. At block 408, receive ecosystem carbon emission data that is generated based on executing the one or more ecosystem management operations, the carbon emissions data comprising client carbon emissions data.

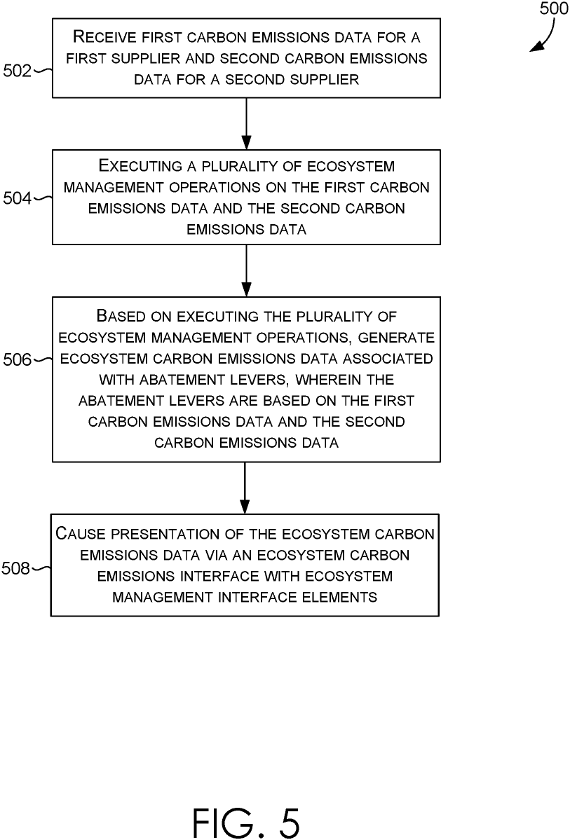

Turning to FIG. 5, a flow diagram is provided that illustrates a method 500 for providing ecosystem carbon emission data using an ecosystem management engine in a carbon emissions management system. At block 502, receive first carbon emissions data for a first supplier and second carbon emissions data for a second supplier. At block 504, execute a plurality of ecosystem management operations on the first carbon emissions data and the second carbon emissions data. At block 506, based on executing the plurality of the ecosystem management operations, generate, using a carbon emissions data analytics engine, ecosystem carbon emissions data associated with abatement levers. The abatement levers are based on the first carbon emissions data and second carbon emissions data. At block 508, cause presentation of the ecosystem carbon emissions data via an ecosystem carbon emissions interface with ecosystem management elements. Ecosystem carbon emissions data comprises a plurality of abatement levers that support quantifying how to reduce the predicted carbon emissions associated with the activities of the value chain model.

### ADDITIONAL SUPPORT FOR DETAILED DESCRIPTION OF THE INVENTION

### Example Distributed Computing System Environment

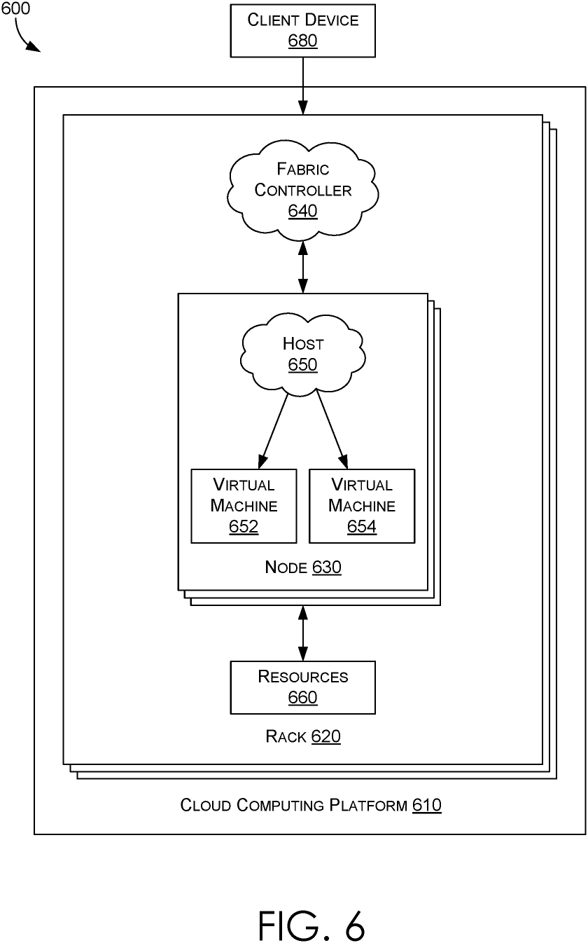

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing infrastructure 610 in a data center can be configured to host and support operation of endpoints of a particular service application. Cloud computing infrastructure 610 may be a public cloud, a private cloud, or a dedicated cloud.

Node 630 can be provisioned with host 650 (e.g., operating system or runtime environment) execution a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 600 described with reference to FIG. 6, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Computing Environment

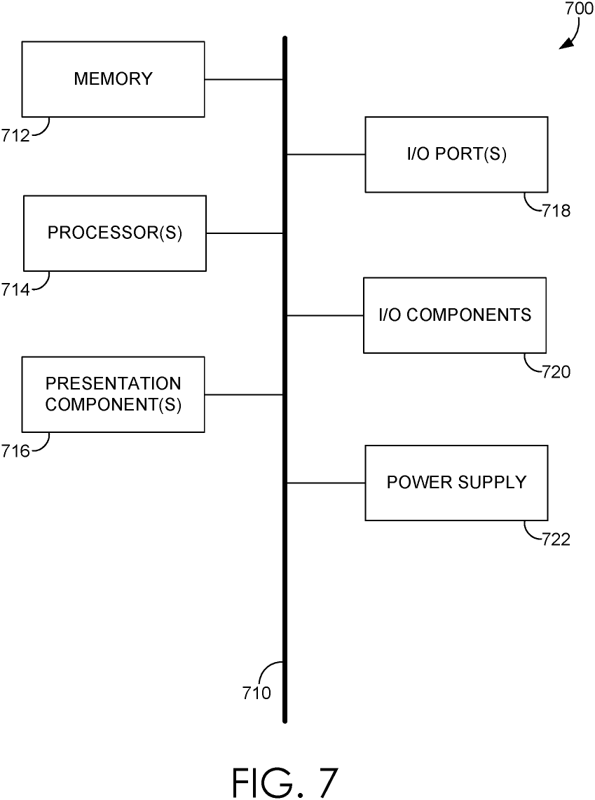

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations comprising:
communicating a request for carbon emissions data from a supplier of a client;
based on communicating the request, receiving the carbon emissions data, wherein the carbon emissions data comprises product-level data of the supplier;
executing one or more ecosystem management operations on the carbon emissions data;
based on executing the one or more ecosystem management operations, generating, using a carbon emissions data analytics engine, ecosystem carbon emissions data comprising client-supplier-specific carbon emissions data associated with the product-level data of the supplier; and
communicating the ecosystem carbon emissions data.

2. The system of claim 1, wherein communicating the request and receiving the carbon emissions data is based on a data request definition associated with a product and product-level carbon emissions data associated with a value chain model of the client and the supplier.

3. The system of claim 1, wherein the carbon emissions data is generated based on self-service product emissions calculation operations that are performed using the carbon emissions data analytics model for calculating carbon emissions data for the supplier.

4. The system of claim 3, wherein the self-service product calculation operations support generating alerts based on benchmarking the carbon emissions data of the supplier.

5. The system of claim 1, wherein executing the one or more ecosystem management operations comprises executing one or more of the following:
performing data validation based on a plurality of data quality rules and benchmarks for carbon emissions data associated with suppliers;
communicating one or more abatement levers that are identified based on processing the carbon emissions data of the supplier using the carbon data analytics model; and
tracking carbon emissions initiatives for the supplier, wherein the ecosystem carbon emissions data includes tracking data of carbon emissions initiatives and an identifier indicating an implementation status of the one or more abatement levers associated with the supplier.

6. The system of claim 1, wherein communicating the ecosystem carbon emissions data comprises causing display of ecosystem interface data comprising dashboard visualizations having ecosystem carbon emissions data graphical interface elements corresponding to the ecosystem carbon emissions data.

7. The system of claim 1, wherein the ecosystem carbon emissions data includes a carbon emissions data analytics recommendation comprising simulated carbon emissions optimization results data based on predicted carbon emissions data generated using a simulation computation and machine learning engine, the predicted carbon emissions data is associated with a value chain model of the client and supplier.

8. One or more computer-storage media having computer-executable instructions embodied thereon that, when executed by a computing system having a processor and memory, cause the processor to:
receive a request for carbon emissions data for a supplier associated with a client;
generate the carbon emissions data associated with product-level data of the supplier based on accessing a product carbon emissions calculator;
communicate the carbon emissions data to cause execution of one or more ecosystem management operations;
receive ecosystem carbon emissions data that is generated based on executing the one or more ecosystem management operations, the carbon emissions data comprising client-supplier-specific carbon emissions data; and
causing display of the ecosystem carbon emissions data.

9. The media of claim 8, wherein communicating the request and receiving the carbon emissions data is based on a data request definition associated with a product and product-level carbon emissions data associated with a value chain model of the client and the supplier.

10. The media of claim 8, wherein the carbon emissions data is generated based on self-service product emissions calculation operations that are performed using the carbon emissions data analytics model for calculating carbon emissions data for the supplier.

11. The media of claim 10, wherein the self-service product calculation operations support generating alerts based on benchmarking the carbon emissions data of the supplier.

12. The media of claim 11, wherein causing display of the ecosystem carbon emissions data is based on dashboard visualizations having ecosystem carbon emissions data graphical interface elements corresponding to the ecosystem carbon emissions data.

13. The media of claim 8, wherein the ecosystem carbon emissions data comprises a plurality of abatement levers that support quantifying how to reduce the predicted carbon emissions associated with the activities of the value chain model.

14. The media of claim 8, wherein the ecosystem carbon emissions data includes a carbon emissions data analytics recommendation comprising simulated carbon emissions optimization results data based on predicted carbon emissions data generated using a simulation computation and machine learning engine, the predicted carbon emissions data is associated with a value chain model of the client and supplier.

15. A computer-implemented method, the method comprising:
receiving first carbon emissions data for a first supplier and second carbon emissions data for a second supplier;
executing a plurality of ecosystem management operations on the first carbon emissions data and the second carbon emissions data;
based on executing the plurality of ecosystem management operations, generating ecosystem carbon emissions data associated with abatement levers, wherein the abatement levers are selected based on the first carbon emissions data and the second carbon emissions data; and
cause presentation of the ecosystem carbon emissions.

16. The method of claim 15, wherein the first carbon emissions data and the second carbon emissions data are generated based on self-service product emissions calculation operations that are performed using the carbon emissions data analytics model for calculating carbon emissions data for a corresponding supplier.

17. The method of claim 15, wherein causing display of the ecosystem carbon emissions data is based on displaying benchmarking data associated with the first carbon emission data and the second carbon emissions data.

18. The method of claim 17, wherein causing display of the ecosystem carbon emissions data is based on dashboard visualizations having ecosystem carbon emissions data graphical interface elements corresponding to the ecosystem carbon emissions data.

19. The method of claim 15, wherein the ecosystem carbon emissions data comprises a plurality of abatement levers that support quantifying how to reduce the predicted carbon emissions associated with the activities of the value chain model.

20. The method of claim 16, wherein the ecosystem carbon emissions data includes a carbon emissions data analytics recommendation comprising simulated carbon emissions optimization results data based on predicted carbon emissions data generated using a simulation computation and machine learning engine, the predicted carbon emissions data is associated with a value chain model of the client and supplier.
